(19) United States
(12) Patent Application Publication
(10) Pub. No.: US 2023/0076428 A1
(43) Pub. Date: Mar. 9, 2023

(54) INTEGRATED NITROGEN REJECTION FOR LIQUEFACTION OF NATURAL GAS

(71) Applicant: Air Products and Chemicals, Inc., Allentown, PA (US)

(72) Inventors: Christopher Michael Ott, Macungie, PA (US); Mark Julian Roberts, Whitehall, PA (US); Annemarie Ott Weist, Macungie, PA (US)

(73) Assignee: Air Products and Chemicals, Inc., Allentown, PA (US)

(21) Appl. No.: 17/464,773

(22) Filed: Sep. 2, 2021

(51) Int. Cl. F23D 14/68; F25J 3/02; F25J 1/00; F17C 5/02

(52) U.S. Cl. CPC F23D 14/68; F25J 3/0214; F25J 1/0022; F25J 3/0257; F17C 5/02; F25J 2200/02; F23K 2400/10; F17C 2227/0341; F17C 2221/033; F17C 2265/015; F17C 2227/0157; F17C 2265/066; F17C 2265/025

(57) ABSTRACT

A method and system for controlling the nitrogen concentration in an LNG product and fuel from flash gas within preferred ranges. A cooled LNG stream is separated into a nitrogen-enriched vapor stream, a fuel stream, and an LNG product stream using a plurality of phase separating devices, such as flash drum or rectifying column. A portion of the vapor stream is recycled to the rectifying column as reflux. A portion of a stream having a higher concentration of nitrogen is combined with the fuel stream to maintain the fuel stream within a desired nitrogen concentration range.

### BACKGROUND

The fuel from a liquid natural gas (LNG) liquefaction process usually comes from flash gas generated at the cold end of a liquefaction unit. Subcooling the LNG to prevent flash generation in the storage tank requires a large amount of refrigeration power. Allowing some flash helps to reduce the refrigeration power. In addition, flash provides an easy way to remove nitrogen from feed gas to maintain nitrogen content at or below the LNG storage specification. The flash gas will contain a higher concentration of nitrogen compared to the feed gas. Accordingly, changes in nitrogen content in the natural gas feed will also affect the nitrogen concentration in the flash gas.

It is desirable to limit nitrogen concentration in the flash gas because the flash gas is used as fuel for gas turbines. In many applications, a maximum nitrogen content of 15-50% is required if the flash gas is to be used to fuel certain gas turbines. If the nitrogen content in the flash gas exceeds the maximum for that gas turbine, it may be necessary to reject excess nitrogen in the form of a pure component that can be vented to the atmosphere.

There are many known solutions for rejecting nitrogen from a natural gas stream, including flash drums, nitrogen strippers, integrated nitrogen rectification columns, and stand-alone nitrogen rejection units (NRUs). These solutions typically produce an on-specification LNG stream and a gas turbine fuel stream. In some cases, the fuel stream will contain relatively high concentrations of nitrogen. If the nitrogen is too high (fuel quality too low), additional nitrogen rejection is needed, producing a high purity nitrogen stream to be vented and a nitrogen depleted fuel stream.

One existing solution uses a nitrogen stripper and reflux arrangement to produce on-specification LNG product and high purity nitrogen. This is a satisfactory solution when the LNG plant is driven by an electric motor utilizing power from the grid and there is no fuel requirement. However, this solution is relatively inflexible and may result in higher nitrogen rejection than is necessary to meet LNG product specifications.

Other existing solutions include an expander process for a multi-component separation process, a nitrogen column using LNG to provide refrigeration, and an NRU that produces LNG and vented nitrogen. None of these solutions allow for control over the nitrogen content in both the LNG product and the fuel stream. Accordingly, these solutions often produce a fuel stream having a much lower nitrogen content than the maximum allowable, which results in unnecessary power consumption, reduced gas turbine power output, and requires larger and more complex equipment. Accordingly, there is a need for an improved system and process to control nitrogen concentration in both the fuel stream and the stored LNG product

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the invention provide an integrated solution to reject nitrogen from only a portion of the flash gas in an LNG liquefaction process. A first portion of the flash gas from a nitrogen stripper or endflash drum is sent to a rectification column. A nitrogen-enriched vapor phase stream containing only trace quantities of hydrocarbons is withdrawn from the top of the rectification column. The nitrogen-enriched vapor phase stream is warmed in a heat exchanger against high pressure recycle vapor and warm feed gas to produce a warmed nitrogen-enriched vapor phase stream. The warmed nitrogen-enriched vapor phase stream is separated into a first portion that is then re-compressed to become a recycle/reflux stream for the rectification column, and a second portion that is vented to atmosphere. The first portion is compressed to form a high-pressure vapor stream that is recycled, cooled, and liquefied against the cold low-pressure nitrogen-enriched vapor stream and a cold liquid stream from the bottoms of the rectification column. The liquefied high pressure recycle stream is then used to reflux the rectification column. Liquid from the bottom of the rectification column is combined with a second portion of flash gas (a flash gas bypass stream) from the nitrogen stripper or endflash drum before being warmed in the previously mentioned heat exchanger against the high pressure recycle vapor stream and the warm feed gas stream. This warmed combined stream is then sent to an endflash compressor to be used as fuel for the gas turbine drivers.

Adjusting the flow of the recycle high pressure stream and the flash gas bypass of the rectification column allows for tight composition control of the nitrogen vented to atmosphere and fuel gas stream.

Alternatively, the liquid from the column may be pumped to reduce the required endflash compressor power and provide a tighter match of the cooling curves in the exchanger.

Several aspects of the systems and methods are outlined below.

Aspect 1: A method for liquefying a natural gas feed stream and removing nitrogen therefrom, the method comprising:

(a) cooling and at least partially liquefying a natural gas feed stream to form a cooled LNG stream having a cooled LNG nitrogen concentration;

(b) performing a plurality of phase separations in downstream fluid flow communication with the cooled LNG stream to produce a nitrogen vapor stream having a vapor stream nitrogen concentration, a fuel stream having a fuel stream nitrogen concentration, and an LNG product stream having an LNG product stream nitrogen concentration, wherein the vapor stream nitrogen concentration is greater than the cooled LNG nitrogen concentration, the fuel stream nitrogen concentration and the LNG product stream nitrogen concentration,

(c) combining the fuel stream with a mixing stream to create a fuel product stream having a fuel product stream nitrogen concentration, the fuel product stream nitrogen concentration being greater than the fuel stream nitrogen concentration, the mixing stream being in downstream fluid flow communication with the cooled LNG stream; and

(d) recycling a recycle stream comprising a portion of the nitrogen vapor stream as reflux for a rectification column;

whereby step (c) enables the fuel product stream nitrogen concentration to be controlled independently of the LNG product stream nitrogen concentration.

Aspect 2: The method of Aspect 1, wherein step (c) further comprises controlling flow of the mixing stream to produce a fuel product stream nitrogen concentration that is within a predetermined fuel product stream nitrogen concentration range.

Aspect 3: The method of any of Aspects 1-2, wherein at least one of the plurality of phase separations of step (b) is performed in a rectification column and the fuel stream is withdrawn as a liquid from a bottom end of the rectification column.

Aspect 4: The method of any of Aspects 1-3, further comprising:

(e) cooling the recycle stream against the nitrogen vapor stream and the fuel stream.

Aspect 5: The method of Aspect 4, wherein step (e) further comprises vaporizing the fuel stream to cool the recycle stream.

Aspect 6: The method of any of Aspects 1-5, further comprising:

(d1) compressing and performing an ambient heat exchange on the recycle stream before performing step (e).

Aspect 7: The method of any of Aspects 1-6, further comprising:

(f) powering at least one gas turbine using the fuel product stream.

Aspect 8: The method of Aspect 7, further comprising:

(g) driving at least one compressor adapted to compress a refrigerant used to perform step (a) using the fuel product stream.

Aspect 9: The method of any of Aspects 1-8, wherein the plurality of phase separations further comprises phase separating the cooled LNG stream to produce a flash gas stream and the LNG product stream.

Aspect 10: The method of Aspect 9, wherein the cooled LNG stream is phase separated using a flash drum.

Aspect 11: The method of any of Aspects 1-10, wherein the cooled LNG stream is phase separated using a rectification column.

Aspect 12: The method of any of Aspects 1-11, wherein the plurality of phase separations further comprises introducing at least a first portion of the flash gas stream into the rectification column to produce the nitrogen vapor stream and the fuel stream.

Aspect 13: The method of Aspect 12, wherein the mixing stream comprises a second portion of the flash gas stream.

Aspect 14: The method of any of Aspects 1-13, wherein the mixing stream is combined with the fuel stream downstream from step (e).

Aspect 15: The method of any of Aspects 1-14, wherein the mixing stream is compressed and cooled before being combined with the fuel stream.

Aspect 16: The method of Aspects 1-15, further comprising:

(h) venting the nitrogen vapor stream.

Aspect 17: The method of any of Aspects 1-16, further comprising:

(h) storing the nitrogen vapor stream.

Aspect 18: A method for liquefying a natural gas feed stream and removing nitrogen therefrom, the method comprising:

(a) at least partially liquefying a natural gas feed stream in a main cryogenic heat exchanger to form a cooled LNG stream having a cooled LNG nitrogen concentration;

(b) separating the cooled LNG stream into an LNG product stream having an LNG product stream nitrogen concentration and a flash gas stream having a flash gas stream nitrogen concentration in a flash drum or rectification column;

(c) separating at least a first portion of the flash gas stream in a rectification column to produce a nitrogen vapor stream having a vapor stream nitrogen concentration, and a fuel stream having a fuel stream nitrogen concentration;

(d) combining the fuel stream with a mixing stream to form a fuel product stream having a fuel product stream nitrogen concentration that is higher than the fuel stream nitrogen concentration, the mixing stream comprising a second portion of the flash gas stream;

(e) dividing the nitrogen vapor stream into a recycle stream and a vent stream;

(f) compressing and cooling the recycle stream; and

(g) further cooling the recycle stream by indirect heat exchange against the fuel stream and the nitrogen vapor stream.

Aspect 19: The method of Aspect 19, wherein the vapor stream nitrogen concentration is greater than the cooled LNG nitrogen concentration, the fuel stream nitrogen concentration, and the LNG product stream nitrogen concentration.

Aspect 20: The method of any of Aspects 19-19, wherein step (d) enables the fuel product stream nitrogen concentration to be controlled independently of the LNG product stream nitrogen concentration.

Aspect 21: The method of any of Aspects 18-20, wherein step (d) further comprises controlling flow of the mixing stream to produce a fuel product stream nitrogen concentration that is within a predetermined fuel product stream nitrogen concentration range.

### BRIEF DESCRIPTION OF THE DRAWING(S)

The present invention will hereinafter be described in conjunction with the appended drawing figures wherein like numerals denote like elements.

FIG. 1 is a schematic flow diagram depicting a method and apparatus for liquefying and removing nitrogen from a natural gas stream according to a first embodiment of the present invention.

FIG. 2 is a schematic flow diagram depicting a method and apparatus according to a second embodiment of the present invention.

FIG. 3 is a schematic flow diagram depicting a method and apparatus according to a third embodiment of the present invention.

FIG. 4 is a schematic flow diagram depicting a method and apparatus according to a fourth embodiment of the present invention.

FIG. 5 is a schematic flow diagram depicting a method and apparatus according to a fifth embodiment of the present invention.

FIG. 6 is a schematic flow diagram depicting a method and apparatus according to a sixth embodiment of the present invention.

FIG. 7 is a schematic flow diagram depicting a method and apparatus according to a seventh embodiment of the present invention.

FIG. 8 is a schematic flow diagram depicting a method and apparatus according to an eighth embodiment of the present invention.

FIG. 9 is a schematic flow diagram depicting a method and apparatus according to a ninth embodiment of the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. Various changes may be made in the function and arrangement of elements without departing from the spirit and scope of the invention.

To aid in describing the invention, directional terms may be used in the specification and claims to describe portions of the present invention (e.g., upper, lower, left, right, etc.). These directional terms are merely intended to assist in describing and claiming the invention and are not intended to limit the invention in any way. In addition, reference numerals that are introduced in the specification in association with a drawing figure may be repeated in one or more subsequent figures without additional description in the specification to provide context for other features.

Unless otherwise indicated, the articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or specified features and may have a singular or plural connotation depending upon the context in which it is used.

The term “conduit,” as used in the specification and claims, refers to one or more structures through which fluids can be transported between two or more components of a system. For example, conduits can include pipes, ducts, passageways, and combinations thereof that transport liquids, vapors, and/or gases.

As used in the specification and claims, the terms “flow communication” or “fluid flow communication” are intended to mean that two or more elements are connected (either directly or indirectly) in a manner that enables fluids to flow between the elements, including connections that may contain valves, gates, tees, or other devices that may selectively restrict, merge, or separate fluid flow.

The term “natural gas”, as used in the specification and claims, means a hydrocarbon gas mixture consisting primarily of methane. As used herein, the term “natural gas” encompasses also synthetic and substitute natural gases. The natural gas feed stream comprises methane and nitrogen (with methane typically being the major component). Typically, the natural gas feed stream has a nitrogen concentration of from 1 to 10 mole percent and the methods and apparatus described herein can effectively remove nitrogen from the natural gas feed stream even where the nitrogen concentration in the natural gas feed stream is relatively low, such as 5 mole percent or below.

The natural gas stream will usually also contain other components, such as for example one or more other hydrocarbons and/or other components such as helium, carbon dioxide, hydrogen, etc. However, it should not contain any additional components at concentrations that will freeze in the main heat exchanger during cooling and liquefaction of the stream. Accordingly, prior to being introduced into the main heat exchanger, the natural gas feed stream may be pretreated if and as necessary to remove water, acid gases, mercury, and heavy hydrocarbons from the natural gas feed stream, to reduce the concentrations of any such components in the natural gas feed stream down to such levels as will not result in any freezing problems.

The terms “hydrocarbon”, “hydrocarbon gas”, or “hydrocarbon fluid”, as used in the specification and claims, means a gas/fluid comprising at least one hydrocarbon and for which hydrocarbons comprise at least 80 mole percent, and more preferably at least 90 mole percent of the overall composition of the gas/fluid.

Unless otherwise stated herein, any and all percentages identified in the specification, drawings, and claims should be understood to be on a mole percentage basis. Unless otherwise stated herein, any and all pressures identified in the specification, drawings, and claims should be understood to mean gauge pressure.

As used in the specification and claims, the term “compression system” is defined as one or more compression stages. For example, a compression system may comprise multiple compression stages within a single compressor. In an alternative example, a compression system may comprise multiple compressors in parallel or in series.

Unless otherwise stated herein, introducing a stream at a location is intended to mean introducing substantially all of the stream at the location. All streams discussed in the specification and shown in the drawings (typically represented by a line with an arrow showing the overall direction of fluid flow during normal operation) should be understood to be contained within a corresponding conduit. Each conduit should be understood to have at least one inlet and at least one outlet. Further, each piece of equipment should be understood to have at least one inlet and at least one outlet.

In the claims, letters are used to identify claimed steps (e.g. (a), (b), and (c)). These letters are used to aid in referring to the method steps and are not intended to indicate the order in which claimed steps are performed, unless and only to the extent that such order is specifically recited in the claims.

It should be noted that, even though the exemplary natural gas liquefaction system embodiments disclosed herein all have closed-loop refrigeration, the inventive concepts disclosed herein are equally applicable to natural gas liquefaction systems using either open-loop or closed-loop compression.

As used herein, and unless otherwise indicated, a stream is “nitrogen-enriched” if the concentration of nitrogen in the stream is higher than the concentration of nitrogen in the natural gas feed stream. A stream is “nitrogen-depleted” if the concentration of nitrogen in the stream is lower than the concentration of nitrogen in the natural gas feed stream.

In the methods and apparatus described herein, and unless otherwise indicated, streams may be expanded and/or, in the case of liquid or two-phase streams, expanded and partially vaporized by passing the stream through any suitable expansion device. A stream may, for example, be expanded and partially vaporized by being passed through an expansion valve or J-T valve, or any other device for effecting (essentially) isenthalpic expansion (and hence flash evaporation) of the stream. Additionally, or alternatively, a stream may, for example, be expanded and partially vaporized by being passed and work expanded through a work-extracting device, such as for example a hydraulic turbine or turbo expander, thereby effecting (essentially) isentropic expansion of the stream.

As used herein, the term “phase separation” is intended to be inclusive of any process that separates one or more input streams into gas and liquid output streams, such as distillation, rectification, stripping, and simple flash separation.

As used herein, the term “rectification column” is intended to refer to columns having only rectification, as well as columns that include both rectification and stripping.

As used herein, the term “main heat exchanger” refers to the heat exchanger responsible for cooling and liquefying all or a portion of the natural gas stream to produce the cooled LNG stream. The heat exchanger may be composed of one or more cooling sections arranged in series and/or in parallel. Each such sections may constitute a separate heat exchanger unit having its own housing, but equally sections may be combined into a single heat exchanger unit sharing a common housing. The heat exchanger unit(s) may be of any suitable type, such as but not limited to shell and tube, wound coil, or plate and fin types of heat exchanger unit. In such units, each cooling section will typically comprise its own tube bundle (where the unit is of the shell and tube or wound coil type) or plate and fin bundle (where the unit is of the plate and fin types).

Some or all of the refrigeration for the main heat exchanger is provided by a closed loop refrigeration system, refrigerant circulated by the closed loop refrigeration system passing through and being warmed in the main heat exchanger and passing through and being warmed in the condenser heat exchanger. The closed loop refrigeration system may be of any suitable type. Exemplary refrigeration systems, comprising one or more close loop systems, that may be used in accordance with the present invention include a single mixed refrigerant (SMR) system, a dual mixed refrigerant (DMR) system, a hybrid propane mixed refrigerant (C3MR) system, an AP-X® system (C3MR or DMR with nitrogen expansion cycle subcooling), a vapor expansion cycle using nitrogen, methane, other gases or mixtures, and other multi-level cascade refrigeration systems, including ConocoPhillips Optimized Cascade® process.

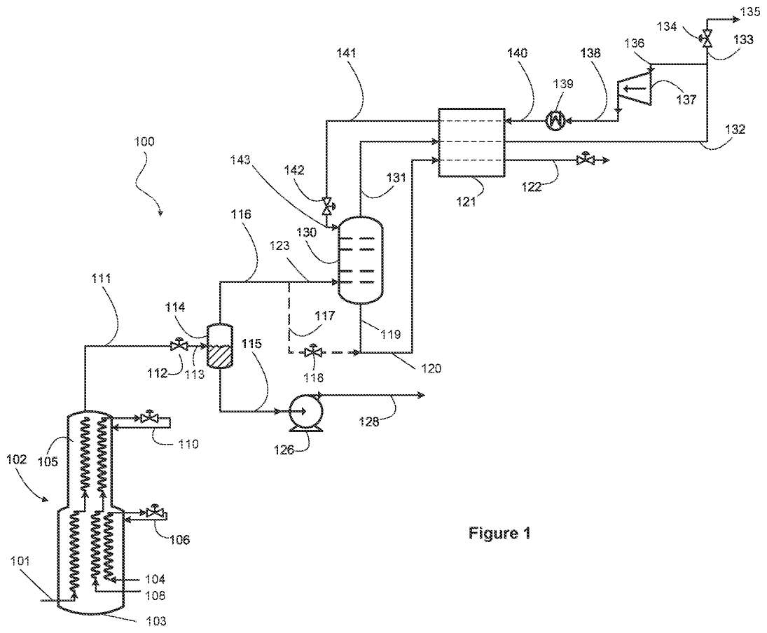

Referring to FIG. 1, an apparatus and method for removing nitrogen from a natural gas feed stream in a natural gas liquefaction system 100 according to one embodiment of the invention is shown. The natural gas feed stream 101 is introduced to the warm end of the main cryogenic heat exchanger (MCHE) 102. A cooled LNG stream 111 is withdrawn from the cold end of the MCHE 102. In the embodiment depicted in FIG. 1, the MCHE 102 is composed of two cooling sections in series, namely, a warm section 103 in which the natural gas feed stream 101 is pre-cooled, and a cold section 105 in which the natural gas feed stream 101 is liquified and sub-cooled. The end of warm section 103 into which the natural gas feed stream 101 is introduced therefore constituting the warm end of the MCHE 102, and the end of the cold section 105 from which the cooled LNG stream 111 is withdrawn therefore constituting the cold end of the MCHE 102.

As will be recognized, the terms ‘warm’ and ‘cold’ in this context refer only to the relative temperatures inside the cooling sections, and do not imply any particular temperature ranges. Each of these sections may constitute a separate heat exchanger unit having its own shell, casing, or other form of housing, but all of the sections could be combined into a single heat exchanger unit sharing a common housing. The heat exchanger may be of any suitable type, such as but not limited to shell and tube, wound coil, or plate and fin types of heat exchanger unit. In such units, each cooling section will typically comprise its own tube bundle (where the unit is of the shell and tube or wound coil type) or plate and fin bundle (where the unit is of the plate and fin types).

In the embodiment depicted in FIG. 1, the refrigeration for the MCHE 102 is provided by a warm bundle refrigerant 104 which is reduced in pressure to form a first cold refrigerant stream 106 which is passed through shell side of the warm section 103 where it provides refrigeration to the warm section. A cold bundle refrigerant 108 is reduced in pressure to form a second cold bundle refrigerant stream 110 which is passed through the shell side of the cold section 104 to provide refrigeration to the cold section. The first and second refrigerants may be the same or different refrigerants and may be part of the same or different open-loop or closed-loop refrigeration systems.

The cooled LNG stream 111 is withdrawn from the cold end of the MCHE 102 and is expanded through a JT valve 112 to produce an expanded cooled LNG stream 113, which is then reduced in pressure in a flash drum 114. A liquid phase LNG product stream 115 from the bottom of the flash drum 114 is pumped through pump 126 and sent to an LNG storage tank (not shown) via a conduit 128. Preferably, the LNG stream 115 has a nitrogen content of less than 1 mole percent.

A flash gas stream 116 is withdrawn from the top of the flash drum 114 and a first portion 123 of the flash gas stream 116 is sent to a rectification column 130. The flash gas stream 116 is enriched in nitrogen relative to the cooled LNG stream 111. Preferably, the flash gas stream 116 has a nitrogen content between 10 and 50 mole percent. In this example, the nitrogen content of the flash gas stream 116 is between 30 and 35 mole percent. A second portion 117 of the flash gas stream 116 forms a bypass stream 117, which will be discussed in greater detail herein.

An overhead stream 131 from the rectification column 130 is warmed in an endflash exchanger 121 to produce a nitrogen vapor stream 132 suitable for venting through a valve 134 to the atmosphere 135. The nitrogen vapor stream 132 preferably has nitrogen concentration of greater than 90 mole percent and, more preferably, greater than 99 mole percent. The nitrogen vapor stream 132 preferably has a methane molar concentration of no more than 1000 ppm and preferably in the range of 0.1 ppm to 1000 ppm.

A rectification column liquid stream, also referred to as a fuel stream 119 is withdrawn from the bottom of the rectification column 130, is optionally combined with the second portion 117 of the flash gas stream 116 to form fuel product stream 120, then warmed and vaporized in the endflash exchanger 121 to produce a vaporized fuel stream 122. The vaporized fuel stream 122 is nitrogen-depleted relative to the cooled LNG stream 111 and preferably has a nitrogen concentration that is very close to, but no greater than, the maximum fuel gas nitrogen concentration required by the equipment being fueled.

Directing a second portion 117 of the flash gas stream 116 to the rectification column liquid stream 119 upstream of the rectification column 130 and providing a means to control the flow of the second portion 117 (in this example, valve 118) enables control of the nitrogen content in the vaporized fuel stream 122 independently of the nitrogen content of the flash gas stream 116. The second portion 117 of the flash gas stream 116 serves as a mixing stream which can be used to control the nitrogen content of the vaporized fuel stream 122. This enables a lower capacity rectification column 130 to be used, reduces the power required to perform the rectification and maximizes the power output of the gas turbines when the nitrogen content of the flash gas stream 116 is higher than the maximum allowed in the fuel. For example, if the maximum acceptable nitrogen concentration for the fuel stream 122 is 15 mole percent, the flow rate of the second portion 117 of the flash gas stream 116 could be controlled to maintain the nitrogen concentration of the fuel stream 122 between 13 and 15 mole percent, preferably within 5% of the maximum nitrogen concentration in the gas turbine fuel, or within 2%, or within 1%.

Preferably, only a first portion 133 of the nitrogen vapor stream 132 is vented to atmosphere 135 via valve 134. A second portion 136 of the nitrogen vapor stream 132 is recompressed in a compressor 137 to produce a compressed nitrogen stream 138. The compressed nitrogen stream 138 is cooled in a cooler 139 to yield a cooled, compressed nitrogen stream 140. The cooled, compressed nitrogen stream 140 is further cooled and liquefied in the endflash exchanger 121 to produce a liquified nitrogen stream 141. The liquified nitrogen stream 141 is expanded in a J-T valve 142 to produce a reflux stream 143 that is returned to the top of the rectification column 130 to provide reflux to the rectification column 130. If the nitrogen concentration in the cooled LNG stream 111 drops below a predetermined value, the valve 134 could be closed, then re-opened if/when the nitrogen concentration in the cooled LNG stream 111 increases. In other words, the nitrogen removal subsystem can be “idled” when nitrogen removal isn't needed and is ready to quickly react if/when nitrogen concentrations increase.

Alternatively, the mixing stream could comprise a portion of stream 133 instead of the second portion 117 of the flash gas stream 116. This would enable the mixing stream to be withdrawn downstream from the endflash exchanger 121, which results in the mixing stream being single phase (instead of potential two-phase for the second portion 117).

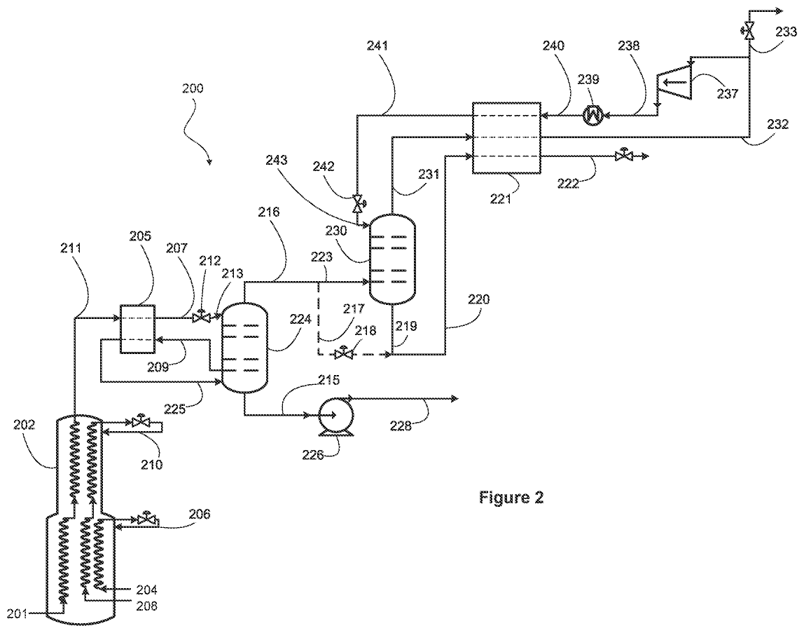

FIG. 2 shows another exemplary embodiment of a natural gas liquefaction system 200. Elements of this embodiment that are also shown and described with respect to FIG. 1 are identified in FIG. 2 reference numerals increased by 100. For example, MCHE 102 in FIG. 1 corresponds to MCHE 202 in FIG. 2. Elements identified in FIG. 2 that do not differ from corresponding elements in FIG. 1 may not be discussed in the specification in connection with FIG. 2.

In the embodiment shown in FIG. 2, the flash drum 114 shown in FIG. 1 is replaced by a reboiler 205 and nitrogen stripper column 224 for the purpose of increasing the concentration of the nitrogen in the nitrogen-enriched vapor phase stream (flash gas) 216 that is sent to the rectification column 230. The cooled LNG stream 211 from the MCHE is subcooled in the reboiler 205 against a bottom stream 209 from the nitrogen stripper column 224. A bottom liquid stream 215 from the nitrogen stripper column 215 is sent to storage via a pump 226 and conduit 228.

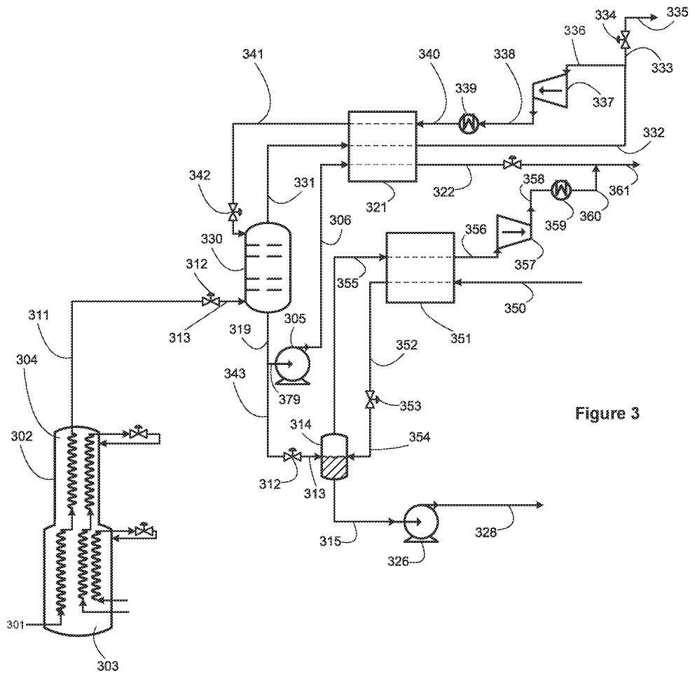

FIG. 3 shows another exemplary embodiment of a natural gas liquefaction system 300, in which the rectification column 330 is provided upstream from the flash drum 314. Elements of this embodiment that are also shown and described with respect to FIG. 1 are identified in FIG. 3 reference numerals increased by 200. For example, MCHE 102 in FIG. 1 corresponds to MCHE 302 in FIG. 3. Elements identified in FIG. 3 that do not differ from corresponding elements in FIG. 1 may not be discussed in the specification in connection with FIG. 3. The cooled LNG stream 311 withdrawn from the MCHE 302 is reduced in pressure by a valve 312 to form an expanded cooled LNG stream 313 that enters the rectification column 330. A rectification column overhead stream 331 that is enriched in nitrogen is warmed in an NRU exchanger 321 to form a nitrogen vapor stream 332. A first portion of the nitrogen vapor stream 333 is vented to atmosphere 335. A second portion 336 of the nitrogen vapor stream 332 is recompressed in a compressor 337, cooled in a cooler 339 and liquefied in the NRU exchanger 321 to be used as reflux in the rectification column 330. In the example, the rectification column 330 is operated at a higher pressure than the flash drum 314. Changing the pressure difference between the rectification column 330 and the flash drum 314 enables control over streams 355 and 306, and therefore ultimately provides independent control over the nitrogen concentration of that fuel product stream 361.

A rectification column liquid stream 319 is withdrawn from the bottom of the rectification column 330. A first portion 379 of the rectification column liquid stream 319 is pumped via pump 305 to become stream 306 and vaporized in the NRU exchanger 321 to ultimately be used as fuel 361. A second portion 343 of the rectification column liquid stream 319 is expanded in a JT valve 312 and flashed in a flash drum 314. The overhead vapor stream 355 from the flash drum 314 is warmed in an endflash exchanger 351 against a natural gas feed stream 350 to form a warmed vapor stream 356 and an LNG stream 352. The LNG stream 352 is expanded as it passes through an expansion valve 353 to form an expanded LNG stream 354, which is introduced into the flash drum 314. The warmed vapor stream 356 is compressed in a compressor 357 to form a compressed warmed vapor stream 358. The compressed warmed vapor stream 358 is cooled in a cooler 359 to form a cooled compressed vapor stream 360. The cooled compressed vapor stream 360 is combined with the vaporized liquids 324 from the rectification column 330 to form a combined fuel product stream 361. Similar to stream 160 of FIG. 1, the fuel product stream 361 has a nitrogen concentration that is slightly less than the concentration that is suitable for use as fuel in a gas turbine. For example, if the maximum acceptable fuel gas nitrogen content for the gas turbine is 30 mole percent, the nitrogen content of the fuel product stream 361 is preferably between 28 and 30 mole percent. Stream 350 is cooled against the overhead vapor stream in the NRU exchanger 321 and sent to the flash drum 314.

Directing a second portion 343 of the rectification column liquid stream 319 to the flash drum 314 to create an overhead vapor stream 355 and providing a means to control the flow of the second portion 343 (in this example, valve 312) enables control of the nitrogen content in the vaporized fuel stream 361 independently of the nitrogen content of the first portion 379 of the rectification column liquid stream 319. The second portion 343 serves as a mixing stream which can be used to control the nitrogen content of the vaporized fuel stream 361. This enables a lower capacity rectification column 330 to be used and reduces the power required to perform the rectification. For example, if the maximum acceptable nitrogen concentration for the vaporized fuel stream 361 is 15 mole percent, the flow rate of second portion 343 of the rectification column liquid stream could be controlled to maintain the nitrogen concentration of the fuel stream 361 between 10 and 15 mole percent.

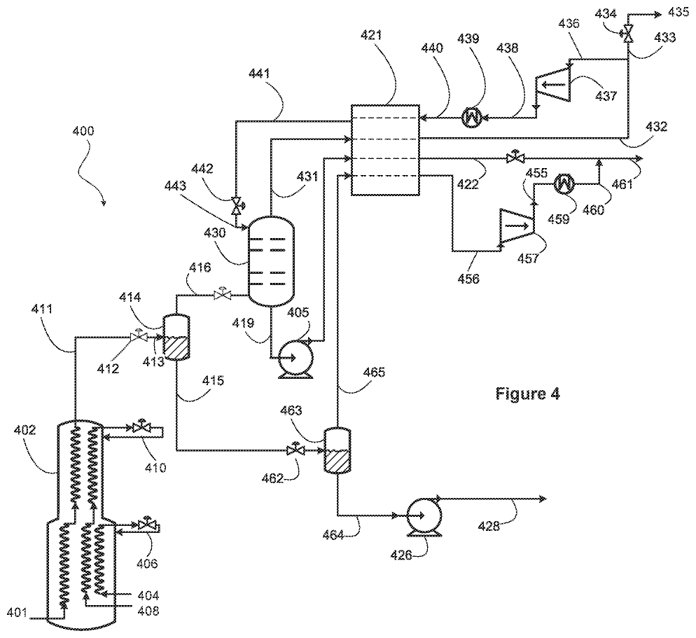

FIG. 4 shows another alternate embodiment of a natural gas liquefaction system 400. Elements of this embodiment that are also shown and described with respect to FIG. 1 are identified in FIG. 4 reference numerals increased by 300. For example, MCHE 102 in FIG. 1 corresponds to MCHE 402 in FIG. 4. Elements identified in FIG. 4 that do not differ from corresponding elements in FIG. 1 may not be discussed in the specification in connection with FIG. 4. In the embodiment of FIG. 4, a high-pressure flash drum 414 is used to improve the efficiency of the nitrogen rectification column 430. A cooled LNG stream 411 from the MCHE 402 is expanded through a JT valve 412 and reduced in pressure in the high-pressure flash drum 414. A flash gas stream 416 is withdrawn from the top of the high-pressure flash drum 414 and is fed to the rectification column 430 to further remove nitrogen from the flash gas and fuel gas. An overhead stream 431 is withdrawn from the top of the rectification column 430 and warmed in an NRU/endflash exchanger 421 to form a nitrogen stream 432. A first portion of the nitrogen stream 433 is vented to atmosphere 435. A second portion of the nitrogen stream 436 is recompressed in a compressor 437, cooled in a cooler 439 and liquefied in the NRU/endflash exchanger 421 to be used as reflux 443 to the nitrogen rectification column 430.

A rectification column liquid stream 419 is withdrawn from the bottom of the rectification column 430 and pumped via a pump to the NRU/endflash exchanger 421 to ultimately be used as fuel 461.

A liquid phase LNG stream 415 is withdrawn from the bottom of the high-pressure flash drum 414. The liquid phase LNG stream 415 from the high-pressure flash drum 414 is expanded through JT valve 462 then flashed and separated in an LNG flash drum 463. An overhead vapor stream 465 is withdrawn from the top of the LNG flash drum 463. The overhead vapor stream 465 is warmed in the NRU/endflash exchanger to form a warmed vapor stream 456. The warmed vapor stream 456 is compressed in a compressor 457 to form a compressed warmed vapor stream 455. The compressed warmed vapor stream 455 is cooled in a cooler 459 to form a cooled compressed vapor stream 460. The cooled compressed vapor stream 460 is combined with the vaporized liquids from the rectification column 424 to form a combined fuel stream 461. Preferably, the combined fuel stream 461 has a nitrogen concentration of less than 15 mole percent and is suitable for use as fuel in a gas turbine.

A liquid phase LNG stream 464 is withdrawn from the bottom of the LNG flash drum 463 and pumped via a pump 426 to storage 428.

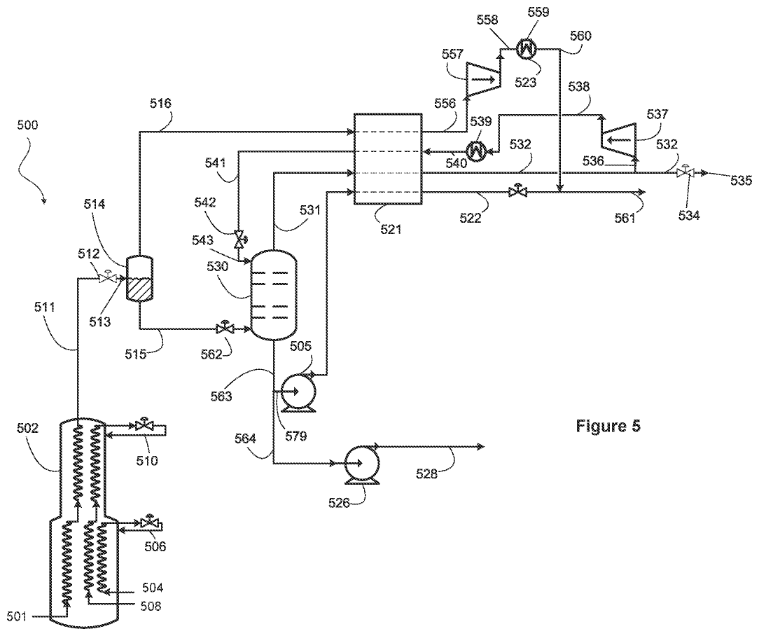

FIG. 5 shows another alternate embodiment of a natural gas liquefaction system 500. Elements of this embodiment that are also shown and described with respect to FIG. 1 are identified in FIG. 5 by reference numerals increased by 400. For example, MCHE 102 in FIG. 1 corresponds to MCHE 502 in FIG. 5. Elements identified in FIG. 5 that do not differ from corresponding elements in FIG. 1 may not be discussed in the specification in connection with FIG. 5. In the embodiment of FIG. 5, a high-pressure flash drum 514 is used to produce a flash gas stream 516 that is warmed and then compressed to fuel pressure to provide a mixing stream 560. The mixing stream 560 is mixed with fuel stream 524 to control the nitrogen concentration in the combined fuel stream 561.

Referring to FIG. 5, a cooled LNG stream 511 from the MCHE 502 is reduced in pressure in the high-pressure flash drum 514. A liquid phase LNG stream 515 is withdrawn from the bottom of the high-pressure flash drum 514. The liquid phase LNG stream 515 from the high-pressure flash drum 514 is expanded through a JT valve 562 fed to the rectification column 530 to further remove nitrogen from the LNG.

A rectification column overhead vapor stream 531 is withdrawn from the top of the rectification column 530. The rectification column overhead vapor stream 531 is enriched in nitrogen compared to the liquid phase LNG stream 515. The rectification column overhead vapor stream 531 is warmed in the NRU/endflash exchanger 521 to form a nitrogen stream 532. A first portion of the nitrogen stream 533 is vented to atmosphere 535. A second portion of the nitrogen stream 536 is recompressed in a compressor 537, cooled in a cooler 539 and liquefied in the NRU/endflash exchanger 521 to be used as reflux to the column 543.

A first portion 579 of the rectification column liquid stream 563 is withdrawn from the bottom of the rectification column 530 and pumped via a pump 505 to the NRU/endflash exchanger 521 where it is warmed and vaporized to form a gas stream that is ultimately used as fuel 561. A second portion 564 of the rectification column liquid stream 563 is transferred via a pump 526 to storage 528.

The flash gas stream 516 from the high-pressure flash drum 514 is warmed in the NRU/endflash exchanger 521 to form warmed vapor stream 556. The warmed vapor stream 556 is compressed in a compressor 557 to form a compressed warmed vapor stream 558. The compressed warmed vapor stream 558 is cooled in a cooler 559 to form a cooled compressed vapor stream 560. The cooled compressed vapor stream 560 is combined with the vaporized liquids from the rectification column 524 to form a combined fuel stream 561. Preferably, the combined fuel stream 561 has a nitrogen concentration less than the maximum nitrogen concentration in the fuel (e.g., 13-15 mole percent if the maximum nitrogen concentration in the fuel is 15%) and is suitable for use as fuel in a gas turbine.

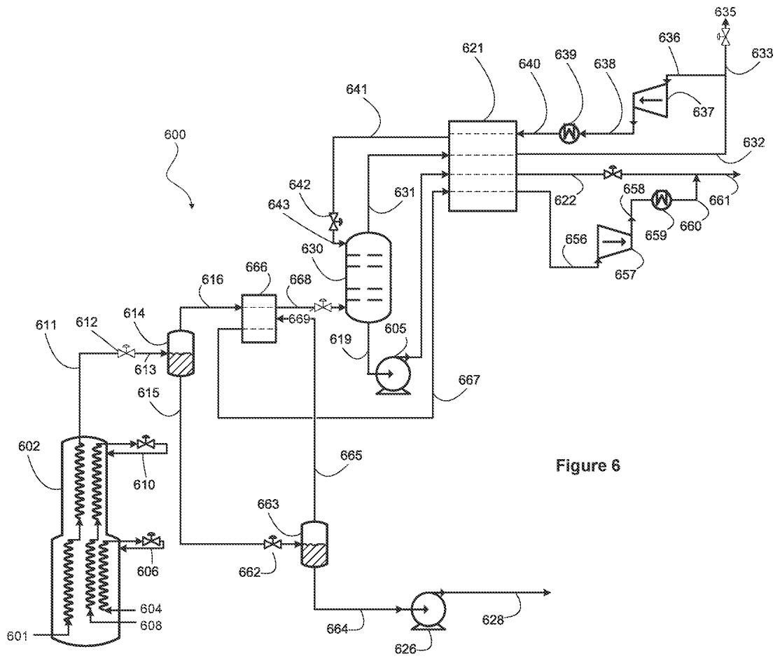

FIG. 6 shows another alternate embodiment of a natural gas liquefaction system 600. Elements of this embodiment that are also shown and described with respect to FIG. 1 are identified in FIG. 6 reference numerals increased by 500. For example, MCHE 102 in FIG. 1 corresponds to MCHE 602 in FIG. 6. Elements identified in FIG. 6 that do not differ from corresponding elements in FIG. 1 may not be discussed in the specification in connection with FIG. 6. In the embodiment of FIG. 6, a high-pressure flash drum 614 is used to improve the efficiency of the nitrogen rectification column 630.

Referring to FIG. 6, a cooled LNG stream 611 from the MCHE 602 is reduced in pressure in the high-pressure flash drum 614.

A flash gas stream 616 is withdrawn from the top of the high-pressure flash drum 614. The flash gas stream 616 is cooled in a heat exchanger 666 against a flash vapor stream 665 from an LNG flash drum 663 to form a cooled nitrogen-enriched vapor stream 668. The cooled nitrogen-enriched vapor stream 668 is expanded through a JT valve 669 and fed to the rectification column 630.

A rectification column overhead vapor stream 631 is withdrawn from the top of the rectification column 630. The rectification column overhead vapor stream 631 is warmed in the NRU/endflash exchanger 621 to form a nitrogen stream 632. A first portion of the nitrogen stream 633 is vented to atmosphere 635. A second portion of the nitrogen stream 636 is recompressed in a compressor 637, cooled in a cooler 639 and liquefied in the NRU/endflash exchanger 621 to be used as reflux to the rectification column 643.

A rectification column liquid stream 619 is withdrawn from the bottom of the rectification column 630 and transferred via a pump to the NRU/endflash exchanger 621 where it is vaporized to form vaporized stream 624, to ultimately be used as fuel 661.

A liquid phase LNG stream 615 is withdrawn from the bottom of the high-pressure flash drum 614. The liquid phase LNG stream 615 is expanded through a JT valve 662, then flashed and separated in the LNG flash drum 663. The flash vapor stream 665 from the LNG flash drum 663 is first warmed against the vapor feed to the rectification column 616 in the heat exchanger 666 then further warmed in the NRU/endflash exchanger 621 to form warmed vapor stream 656. The warmed vapor stream 656 is compressed in a compressor 657 to form a compressed warmed vapor stream 658. The compressed warmed vapor stream 658 is cooled in a cooler 659 to form a cooled compressed vapor stream 660. The cooled compressed vapor stream 660 is combined with the vaporized liquids from the rectification column 630 to form a combined fuel stream 661. Preferably, the combined fuel stream 661 has a nitrogen concentration of less than 15 mole percent and is suitable for use as fuel in a gas turbine.

A liquid LNG stream 664 is removed from the bottom of the LNG flash drum 663 and transferred via a pump 626 to storage 628.

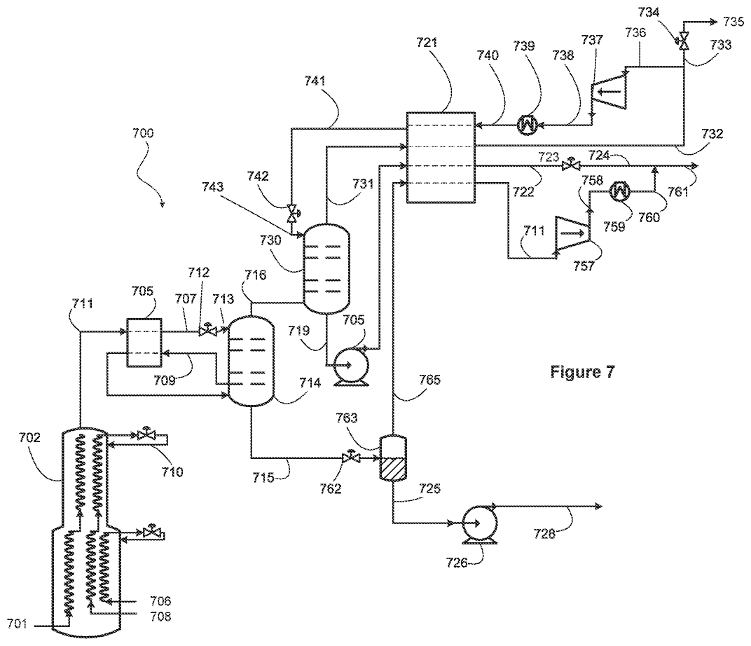

FIG. 7 shows an alternate embodiment of a natural gas liquefaction system 700. Elements of this embodiment that are also shown and described with respect to FIG. 1 are identified in FIG. 7 reference numerals increased by 600. For example, MCHE 102 in FIG. 1 corresponds to MCHE 702 in FIG. 7. Elements identified in FIG. 7 that do not differ from corresponding elements in FIG. 1 may not be discussed in the specification in connection with FIG. 7. In the embodiment of FIG. 7, a high-pressure nitrogen stripper column 705 replaces the high-pressure flash drum 414 of FIG. 4.

Referring to FIG. 7, a cooled LNG stream 711 from the MCHE 702 is subcooled against a reboiler stream 709 from the bottom of the nitrogen stripper column 714. An overhead vapor stream 716 from the high-pressure nitrogen stripper column 714 is fed to the rectification column 730 to remove nitrogen from the flash/fuel gas. Nitrogen vapor from the column 731 is warmed in the NRU/endflash exchanger 721 to form a nitrogen stream 732. A first portion of the nitrogen stream 733 is vented to atmosphere 735. A second portion of the nitrogen stream 736 is recompressed (in compressor 737), cooled (in a heat exchanger 739) and liquefied in the NRU/endflash exchanger 721 to be used as reflux 743 to the column 730.

The liquid 719 from the rectification column 730 is pumped 705 and vaporized in the NRU/endflash exchanger 721 to be used as fuel 761. A liquid stream 715 from the nitrogen stripper column 714 is flashed and separated in the LNG flash drum 763. A vapor stream 765 from the LNG flash drum 763 is used to create a mixing stream to be used to control the nitrogen concentration in the fuel product stream 761. The vapor stream 765 from the LNG flash drum 763 is warmed in the NRU/endflash exchanger 721 and combined with the vaporized liquids from the rectification column 730. The combined fuel stream 761 has reduced nitrogen content (less than 15% nitrogen) suitable for fuel in a gas turbine. An LNG product stream 725 is withdrawn from the LNG flash drum 763 and sent to storage 728.

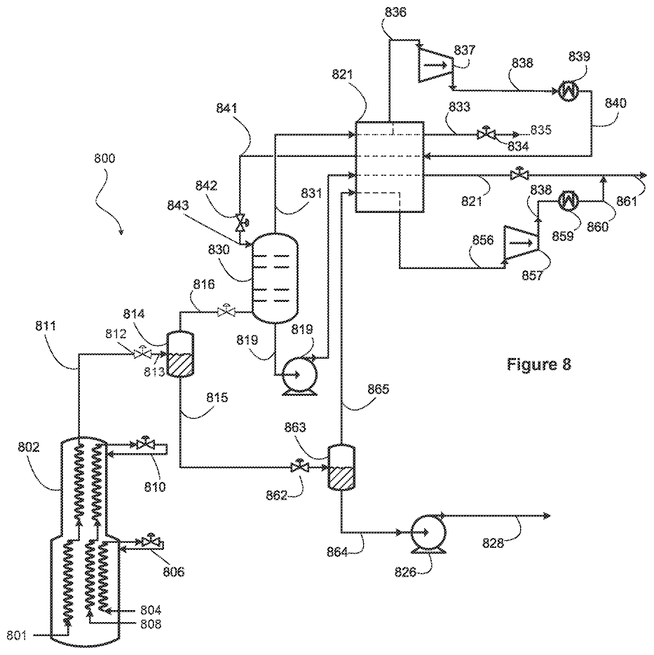

FIG. 8 shows another alternate embodiment of a natural gas liquefaction system 800. Elements of this embodiment that are also shown and described with respect to FIG. 1 are identified in FIG. 8 reference numerals increased by 700. For example, MCHE 102 in FIG. 1 corresponds to MCHE 802 in FIG. 8. Elements identified in FIG. 8 that do not differ from corresponding elements in FIG. 1 may not be discussed in the specification in connection with FIG. 8. In the embodiment of FIG. 8, the system of FIG. 4 is modified such that the NRU/endflash exchanger 821 compresses the recycled nitrogen 836 that is used for reflux 843 at a colder temperature than the nitrogen that is vented to atmosphere 835.

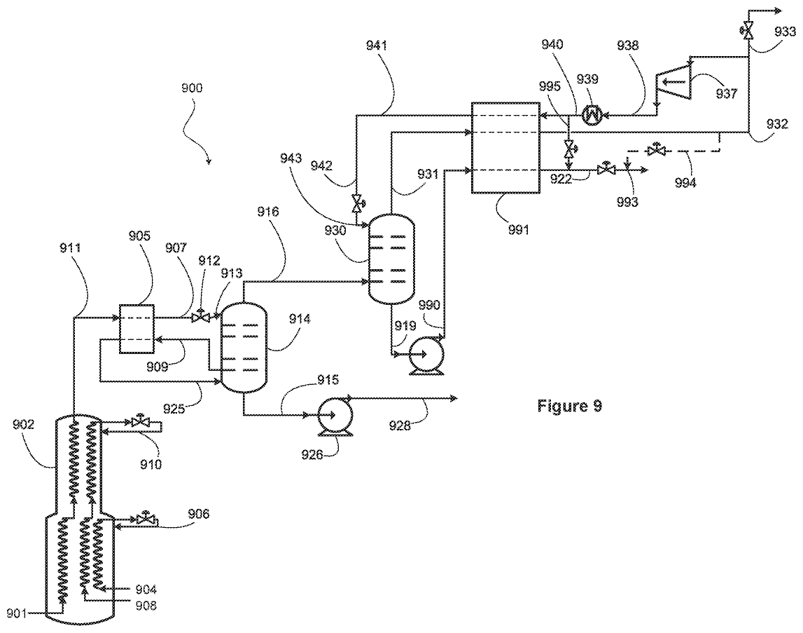

FIG. 9 shows another alternate embodiment of a natural gas liquefaction system 900. Elements of this embodiment that are also shown and described with respect to FIG. 1 are identified in FIG. 8 reference numerals increased by 800. For example, MCHE 102 in FIG. 1 corresponds to MCHE 902 in FIG. 9. Elements identified in FIG. 9 that do not differ from corresponding elements described in a previous figure may not be discussed in the specification in connection with FIG. 9. The embodiment of FIG. 9 is very similar to the embodiment shown in FIG. 2. In this embodiment 900, the mixing stream used to independently control the nitrogen content of the fuel gas stream 993 is a stream 995 split from the compressed nitrogen stream 940. This arrangement provides the ability to the pump the liquid 919 from rectification column 930 in a pump to reduce or eliminate the fuel compressor requirements. Alternatively, the control of nitrogen content of the fuel gas stream 993 can be provided by a stream 994 split from the nitrogen vapor stream 932.

### EXAMPLE

Table 1 is a modeled example of operation of the natural gas liquefaction and nitrogen removal system of the embodiment shown in FIG. 2. This example is based on a feed gas stream 201 with nominally 2.5% nitrogen. The process has been optimized to produce LNG with less than 0.65% nitrogen, fuel with less than 23.5% nitrogen, nitrogen vented to atmosphere with 800 ppm of methane.

TABLE 1

| Stream (Figure2) | 211 | 207 | 228 | 216 | 219 | 220 | 222 | 231 | 233 | 241 |
|---|---|---|---|---|---|---|---|---|---|---|
| Parameter | | | | | | | | | | |
| Pressure (bara) | 75.5 | 75.0 | 7.0 | 1.2 | 1.3 | 1.2 | 1.0 | 1.2 | 17.8 | 17.3 |
| Temp (C.) | −152.0 | −159.2 | −159.2 | −162.9 | −163.0 | −163.8 | 27.5 | −193.9 | 40.8 | −178.1 |
| Mass Flow (kg/hr) | 318,751 | 318,751 | 305,163 | 21,703 | 4,853 | 17,797 | 17,797 | 19,622 | 3,907 | 15,715 |
| Composition (%) | | | | | | | | | | |
| N2 | 2.53% | 2.53% | 0.62% | 33.22% | 2.00% | 23.37% | 23.37% | 99.92% | 99.92% | 99.92% |
| C1 | 89.38% | 89.38% | 90.78% | 66.77% | 97.99% | 76.62% | 76.62% | 0.08% | 0.08% | 0.08% |
| C2 | 6.82% | 6.82% | 7.24% | 0.01% | 0.01% | 0.01% | 0.01% | 0.00% | 0.00% | 0.00% |
| C3 | 1.10% | 1.10% | 1.17% | 0.00% | 0.00% | 0.00% | 0.00% | 0.00% | 0.00% | 0.00% |
| I4 | 0.06% | 0.06% | 0.06% | 0.00% | 0.00% | 0.00% | 0.00% | 0.00% | 0.00% | 0.00% |
| C4 | 0.10% | 0.10% | 0.11% | 0.00% | 0.00% | 0.00% | 0.00% | 0.00% | 0.00% | 0.00% |
| I5 | 0.01% | 0.01% | 0.01% | 0.00% | 0.00% | 0.00% | 0.00% | 0.00% | 0.00% | 0.00% |

As such, an invention has been disclosed in terms of exemplary embodiments and alternate embodiments thereof. Of course, various changes, modifications, and alterations from the teachings of the present invention may be contemplated by those skilled in the art without departing from the intended spirit and scope thereof. It is intended that the present invention only be limited by the terms of the appended claims.

1. A method for liquefying a natural gas feed stream and removing nitrogen therefrom, the method comprising:
(a) cooling and at least partially liquefying a natural gas feed stream to form a cooled LNG stream having a cooled LNG nitrogen concentration;
(b) performing a plurality of phase separations in downstream fluid flow communication with the cooled LNG stream to produce a nitrogen vapor stream having a vapor stream nitrogen concentration, a fuel stream having a fuel stream nitrogen concentration, and an LNG product stream having an LNG product stream nitrogen concentration, wherein the vapor stream nitrogen concentration is greater than the cooled LNG nitrogen concentration, the fuel stream nitrogen concentration and the LNG product stream nitrogen concentration,
(c) combining the fuel stream with a mixing stream to create a fuel product stream having a fuel product stream nitrogen concentration, the fuel product stream nitrogen concentration being greater than the fuel stream nitrogen concentration, the mixing stream being in downstream fluid flow communication with the cooled LNG stream; and
(d) recycling a recycle stream comprising a portion of the nitrogen vapor stream as reflux for a rectification column;
whereby step (c) enables the fuel product stream nitrogen concentration to be controlled independently of the LNG product stream nitrogen concentration.

2. The method of claim 1, wherein step (c) further comprises controlling flow of the mixing stream to produce a fuel product stream nitrogen concentration that is within a predetermined fuel product stream nitrogen concentration range.

3. The method of claim 1, wherein at least one of the plurality of phase separations of step (b) is performed in a rectification column and the fuel stream is withdrawn as a liquid from a bottom end of the rectification column.

4. The method of claim 1, further comprising:
(e) cooling the recycle stream against the nitrogen vapor stream and the fuel stream.

5. The method of claim 4, wherein step (e) further comprises vaporizing the fuel stream to cool the recycle stream.

6. The method of claim 4, further comprising:
(d1) compressing and performing an ambient heat exchange on the recycle stream before performing step (e).

7. The method of claim 1, further comprising:
(f) powering at least one gas turbine using the fuel product stream.

8. The method of claim 7, further comprising:
(g) driving at least one compressor adapted to compress a refrigerant used to perform step (a) using the fuel product stream.

9. The method of claim 1, wherein the plurality of phase separations further comprises phase separating the cooled LNG stream to produce a flash gas stream and the LNG product stream.

10. The method of claim 9, wherein the cooled LNG stream is phase separated using a flash drum.

11. The method of claim 9, wherein the cooled LNG stream is phase separated using a rectification column.

12. The method of claim 9, wherein the plurality of phase separations further comprises introducing at least a first portion of the flash gas stream into the rectification column to produce the nitrogen vapor stream and the fuel stream.

13. The method of claim 12, wherein the mixing stream comprises a second portion of the flash gas stream.

14. The method of claim 1, wherein the mixing stream is combined with the fuel stream downstream from step (e).

15. The method of claim 1, wherein the mixing stream is compressed and cooled before being combined with the fuel stream.

16. The method of claim 1, further comprising:
(h) venting the nitrogen vapor stream.

17. The method of claim 1, further comprising:
(h) storing the nitrogen vapor stream.

18. The method of claim 1, wherein step (d) further comprises controlling flow of the mixing stream to produce a fuel product stream nitrogen concentration that is within a predetermined fuel product stream nitrogen concentration range.

19. A method for liquefying a natural gas feed stream and removing nitrogen therefrom, the method comprising:
(a) at least partially liquefying a natural gas feed stream in a main cryogenic heat exchanger to form a cooled LNG stream having a cooled LNG nitrogen concentration;
(b) separating the cooled LNG stream into an LNG product stream having an LNG product stream nitrogen concentration and a flash gas stream having a flash gas stream nitrogen concentration in a flash drum or rectification column;
(c) separating at least a first portion of the flash gas stream in a rectification column to produce a nitrogen vapor stream having a vapor stream nitrogen concentration, and a fuel stream having a fuel stream nitrogen concentration;
(d) combining the fuel stream with a mixing stream to form a fuel product stream having a fuel product stream nitrogen concentration that is higher than the fuel stream nitrogen concentration, the mixing stream comprising a second portion of the flash gas stream;
(e) dividing the nitrogen vapor stream into a recycle stream and a vent stream;
(f) compressing and cooling the recycle stream; and
(g) further cooling the recycle stream by indirect heat exchange against the fuel stream and the nitrogen vapor stream.

20. The method of claim 19, wherein the vapor stream nitrogen concentration is greater than the cooled LNG nitrogen concentration, the fuel stream nitrogen concentration, and the LNG product stream nitrogen concentration.

21. The method of claim 19, wherein step (d) enables the fuel product stream nitrogen concentration to be controlled independently of the LNG product stream nitrogen concentration.
